(19) United States
(12) Patent Application Publication
(10) Pub. No.: US 2006/0262366 A1
(43) Pub. Date: Nov. 23, 2006

(54) Holograms with a discontinuous metal layer comprising regions of dissimilar transmittance and articles incorporating them

(76) Inventors: Salvatore D'amato, Robbinsville, NJ (US); William C. Morwald, Langhorne, PA (US); George Karcich, Park Ridge, NJ (US); Michael Banahan, Montebello, NY (US)

Correspondence Address: FULBRIGHT & JAWORSKI, LLP, 666 FIFTH AVE, NEW YORK, NY, 10103-3198, US

(21) Appl. No.: 11/434,946

(22) Filed: May 16, 2006

Related U.S. Application Data
(60) Provisional application No. 60/683,205, filed on May 20, 2005.
(60) Provisional application No. 60/684,916, filed on May 25, 2005.

(51) Int. Cl. G03H 1/00

(52) U.S. Cl. 359/2; 359/3

(57) ABSTRACT

A holographic overlay comprising a holographic design and a plurality of zones of varying transmittance to increase viewability of underlying information-bearing areas of a document. The plurality of zones are generated and applied in register to the underlying document.

### RELATED APPLICATION

The application claims priority benefit under Title 35 U.S.C. §119(e) of provisional patent application Nos. 60/683,205 filed May 20, 2005 and 60/684,916 filed May 25, 2005, each of which is incorporated by reference in its entirety.

### BACKGROUND OF THE INVENTION

The present invention relates to improvements of “demetallized” or “pattern metallized” holographic overlaminates well known in the anti-counterfeiting industry.

Traditional applications of demetallized holographic products and pattern metallized holographic products are limited in their effectiveness. Certain documents requiring a tamper-evident functionality and/or an anti-counterfeiting aspect contain information that must be unobstructed and readily viewable (or readable) upon inspection of the document, as is the case with personal identification cards, for example. Traditional demetallized and pattern metallized (hereinafter referred to as discontinuous metallized) holographic overlaminates or labels can obscure certain underlying printed information, thereby compromising the effectiveness of the document.

This problem is compounded if the pattern metallized area is designed to enhance the holographic element via increased metal coverage or density. Inversely, discontinuous metallized holographic products by their very nature reduce reflectivity by decreasing the amount of metal proximate to the holographic interface. The desired effect of increasing the transmission of impinging illumination through the holographic substrate thereby increasing viewability of the underlying document information is achieved at the expense of decreasing the amount of light that diffracts from the holographic substrate. This causes a reduced holographic effect. The usual method of dealing with this dilemma is to balance the transmission through the holographic substrate with the reflection from the diffracting surface so that a compromise between the viewability of the information-bearing and holographic elements is reached. Unfortunately many times, this is an undesirable compromise and would be avoided if there were a holographic overlaminate product that preserves certain areas of the holographic design and also allow relatively higher transmission through regions overlying certain other information-bearing areas of the underlying document.

### OBJECT AND SUMMARY OF THE INVENTION

The present invention avoids the above-described limitations through the use of multiple, coplanar regions of discontinuous metallization of dissimilar and varying transmittance. A range of transmittance values, from zero (full metallization) to nearly 100% (transparent), is used to obtain different effects within the same label or document overlay, the selection of which is determined in accordance with the underlying information-bearing regions. The discontinuous metallization pattern is applied in such a manner so as to provide the desired transparent and opaque regions, and varying degrees thereof, in spatial relation to particular information of interest within the information-bearing layer.

An object of the present invention is, therefore, to provide an improved and novel holographic overlay such that a compromise between the visibility of the hologram and the visibility of the underlying information is not necessitated.

Another object of the present invention is to generate documents with highly visible holographic features that diffract brightly and therefore offer a higher degree of counterfeit protection and ease of authentication.

A further object of the present invention is to provide the improved and novel holographic overlay as aforesaid without obstructing the critical underlying information, whether this information is viewable by a human eye or machine-readable, e.g., a printed bar code.

It is yet another object of the present invention to design, generate and apply the regions of the discontinuous metal layer to register with the underlying information on the document.

It is still another object of the present invention to design the holographic information layout to interact with both the discontinuous metallized layer and the underlying information-bearing layer, thereby enhancing the overall functionality or esthetic quality of the finished document. That is to say, certain document information-bearing areas are not only aligned to certain discontinuous metallized zones, but certain discontinuous metallized zones are aligned to features of the holographic design to provide an even higher degree of effectiveness.

The present invention applies to documents that utilize registered holographic patterns as well as to documents that utilize non-registered holographic patterns, or “wallpaper” patterns, as they are known in the industry.

In accordance with an embodiment of the present invention, the spatial configuration of the underlying document information prescribes the composition of the superjacent discontinuous metallized pattern. It is generally known beforehand which areas of the underlying document are to bear information of relatively higher value or significance. The locations of these high value information bearing areas influence the design of the discontinuous metallized pattern. In these high value information bearing areas of the discontinuous metallized pattern, the present invention uses as little average metal density as possible so as to fully expose the underlying information while still providing security from attempts to tamper with or otherwise modify this information. This can be achieved by any of several techniques. In accordance with an exemplary embodiment of the present invention, the screen density of a multiply connected array of metal dots can be decreased by decreasing dot size at a given frequency or alternatively by decreasing frequency at a given dot size. It is appreciated that this applies to screen motifs as well as multiply connected dot patterns. Alternatively, the area can be completely devoid of metal or contain minimal metal-bearing regions so as to provide the highest degree of transmittance possible. It is in these low metal density areas that the hologram layer will diffract incident illumination least efficiently. In areas of the document that contain little information or information of relatively low value, higher degrees of opacity in the metallized pattern can be used without fear of occluding information of interest. A high average metal density is incorporated in this area in accordance with an embodiment of the present invention, for example in the form of a relatively high gain dot or screen pattern. Alternatively, the high metal density area can be completely devoid of transparent regions in accordance with an aspect of the present invention so as to provide the highest degree of reflectance possible. It is in these high metal density areas that the hologram layer will diffract incident illumination most efficiently.

In accordance with an exemplary embodiment of the present invention, an attractive, highly functional and secure document can be generated by a creative application of varying screens, dot patterns, filigreed design, corporate logos, indicia, etc. Those areas of the document that contain information of importance are kept relatively free of overlying metal, and those areas of the document that do not contain such information can, but are not necessarily required to, exhibit relatively high degrees or even full opacity of the discontinuous metallized layer, thereby maximizing diffraction efficiency.

In accordance with an embodiment of the present invention, the holographic layer can be designed in accordance with both the underlying document layout and the discontinuous metallized layer. This technique allows for a further degree of creativity and design capability enabling the generation of rather complex and visually stunning documents that simultaneously exhibit a high degree of security. This type of design is also particularly effective in creating “zones of security,” where it becomes virtually impossible to alter information underlying certain holographic features that are deliberately located so as to be immediately superjacent to this information. The discontinuous metallized layer design is then composed so as to enhance this security effect. It is appreciated that the discontinuous metallized layer should be manufactured or applied in register to the holographic layer design. This is not the case with repeating or “wallpaper” holographic design; the discontinuous metallized layer need not be manufactured or applied in register to such a design for there is no set registration between them. In both cases, however, it is required that the discontinuous metallized layer-containing substrate itself be manufactured or applied in register to the information-bearing document, regardless of the registration, or lack thereof, of the holographic layer design to the information-bearing document.

In accordance with an embodiment of the present invention, a holographic overlay comprises a plurality of zones of varying transmittance to increase viewability of underlying information-bearing areas of a document and holographic design.

In accordance with an embodiment of the present invention, a method of generating holographic overlay comprises the steps of metallizing a holographic layer comprising a holographic design and demetallizing the metallized holographic layer with a discontinuous metallization pattern to provide the holographic overly comprising multiple zones of dissimilar transmittance.

In accordance with an embodiment of the present invention, a method of generating holographic overlay comprises the steps of applying a metallization-resistant image pattern to a holographic imaged layer comprising a holographic design and selectively metallizing the holographic imaged layer with a discontinuous metallization pattern to provide said holographic overly comprising multiple zones of dissimilar transmittance.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 illustrates an identification document, which incorporates a demetallized holographic overlaminate in accordance with an exemplary embodiment of the present invention;

FIG. 2 depicts the information bearing and demetallized holographic layers laminated in register to form the final document with integral demetallized holographic overlay in accordance with an exemplary embodiment of the present invention;

FIG. 3 illustrates an identification document incorporating the holographic overlay in accordance with an embodiment of the present invention;

FIG. 4 is a schematic diagram of registered demetallizing machine in accordance with an exemplary embodiment of the present invention;

FIG. 5 is a schematic diagram of the laminating/printing/die cutting machine in accordance with an exemplary embodiment of the present invention;

FIG. 6 is a schematic diagram of the ID card printer/laminator in accordance with an exemplary embodiment of the present invention;

FIG. 7 is a schematic diagram of a metallizer for selective metallization in accordance with an exemplary embodiment of the present invention.

### DETAILED DESCRIPTIONS OF THE EMBODIMENTS

Turning now to FIG. 1, there is illustrated an identification document 101, such as an identification card, a credit card and the like, that incorporates a photo of the cardholder 105 and identifying information 103. The information in zone 106 (i.e., the high value information bearing area such as a bar code) indicates the cardholder's vital information. Situated above the document 101 is a selective metallized holographic overlaminate or a demetallized holographic overlaminate (collectively referred to herein as the holographic overlaminate 107) that contains a holographic design 109 and a zone 108 that exhibits higher transmittance than the surrounding area of overlaminate 107 in accordance with an exemplary embodiment of the present invention.

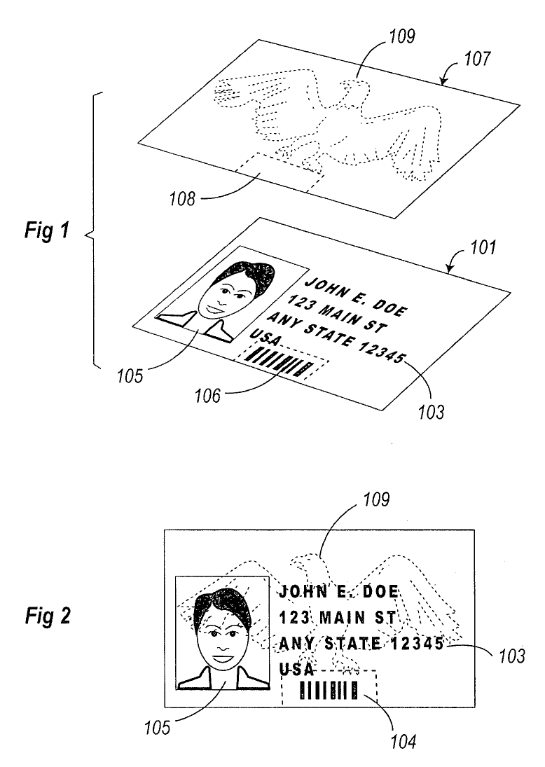

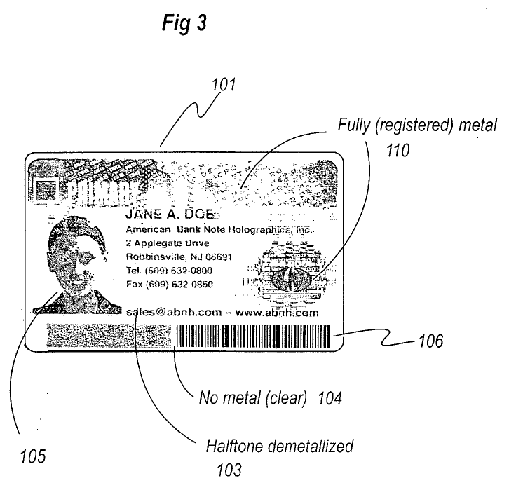

FIG. 2 depicts the two layers 101 and 107 shown in FIG. 1 laminated in register to form the final document with integral selectively metallized or demetallized holographic overlay in accordance with an exemplary embodiment of the present invention. Cardholder's photo 105 is partially overlaid with the holographic image 109, as is information-bearing area 103. The overall effect is a partial diffraction because all areas of overlaminate 107 are metallized or demetallized to a 30% screen density with the exception of zone 108, which is entirely demetallized (or not metallized) and is completely transparent. In FIGS. 2 and 3, a zone 104 comprises zones 108 and 106, and allows a completely unobstructed view of the underlying information contained within the document 101.

The following examples are exemplary in nature and are not meant to limit the scope of the invention in any way.

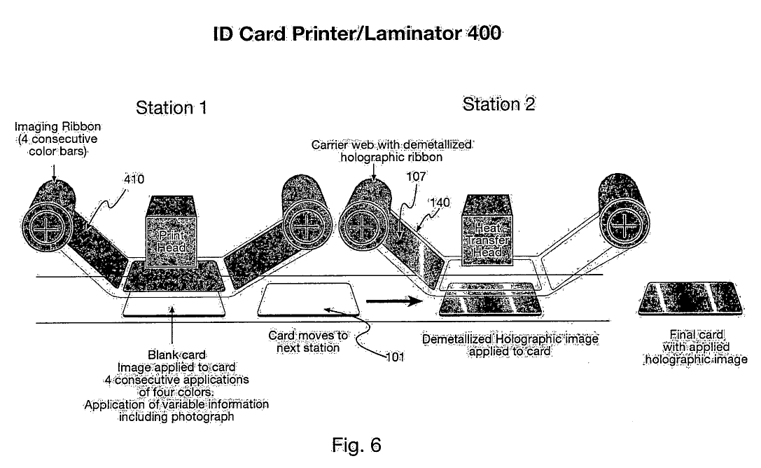

In accordance with an exemplary embodiment of the present invention, a holographic overlaminate patch 107 is applied to a national identification card 101 (see FIGS. 1 and 3). The cards 101 are printed and overlaminated in a single pass at point of issue using a dye sublimation printer with integral lamination capability, such as ID card printer/laminator 400 in FIG. 6. Alternatively, these cards 101 can printed and sheeted in multiple card configurations and laminated in sheet form to be die cut later into individual cards 101. The holographic overlaminate patch 107 is supplied on a release liner, wound on a spool so as to fit the specific model printer. Alternatively, the holographic overlaminate is supplied in multiple image sheet form and laminated into a multiple card sheet form. However, there are several areas on the identification card 101 that the issuer specifies must be covered by no more than a 30% screen. Turning to FIG. 3, these areas are a 20×40 mm rectangle 106 on the bottom right of the card 101 and an area 103 in the center of the card 101, where the subjects' personal identifying information is listed (i.e., address information and barcode), and a 25×25 mm rectangle 105 on the left side, where the subjects' color photo will be printed. In accordance with an aspect of the present invention, there is an additional 4 mm margin can be provided around these zones to allow for application registration error in both the x- and y-axes. Elsewhere on the card 101, there is a 60% screen specified, with the exception of a 5 mm high strip 110 along the top of the card, which will retain 100% metal coverage, as shown in FIG. 3. The artist lays out the holographic production plate in such a manner that the seams between successive holographic plates will not be apparent in the live area of an ID card once laminated.

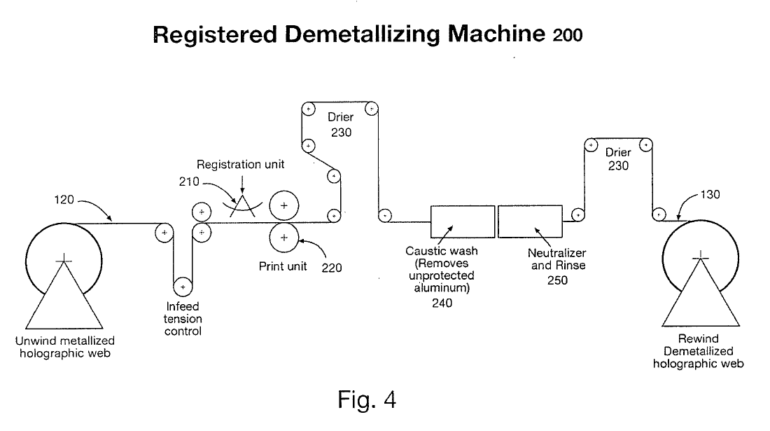

In accordance with an embodiment of the present invention, the holographic plate is generated using known holographic mastering techniques, and a nickel stamper is grown from its surface. The holographic nickel stamper is then mounted to a cylinder and replicated into a large web of base film material. It is appreciated that a holographic web can be manufactured using other known techniques, such as casting. In accordance with an exemplary embodiment of the present invention, the roll of holographic material 125 is then metallized with aluminum, chrome or other suitable material using standard vacuum metallizing techniques and then mounted on a demetallizing machine with register capabilities, such as a registered demetallizing machine 200 in FIG. 4. The demetallizing machine 200 comprises a registration unit 210, a print unit 220, driers 230, a caustic station 240 and a neutralizer/rinse station 250. The print unit 220 prints a pattern of resist using any known printing technique, the resist being applied in register with the holographic image by the registration unit 210, that has been designed by the artist to reflect the above-described requirements of the card issuer. The pattern consists of multiple regions of dissimilar transmittance, designed in accordance with an embodiment of the present invention, to be applied in register to the specified identification card 101. The registered demetallizing machine 200 applies the same pattern multiply across the metallized holographic web 120, to each “lane” that will eventually be slit down into the final product. Once the pattern has been printed on the metallized holographic web 120, it passes through several curing heaters or driers 230 (such as hot air driers, UV driers and the like), after which the resist is fully cured. The web 120 then passes through a caustic station 240 where the aluminum is etched from the surface in those places not protected by the resist. Once clear of the caustic station 240, the web 120 is neutralized with an acid wash and then rinsed thoroughly at the neutralizer/rinse station 250 and dried using the driers 230. This is the process by which the registered demetallizing machine 200 produces a demetallized holographic web 130 from a metallized holographic web 120 in accordance with an exemplary embodiment of the present invention. In accordance with an aspect of the present invention, the registered demetallizing machine 200 can print caustic pattern on the metallized holographic web 120, thereby eliminating the need to apply a resist pattern.

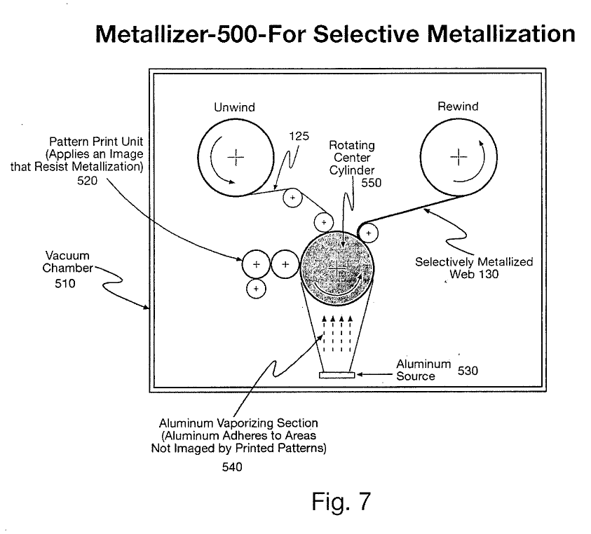

Alternatively, instead of demetallizing the metallized holographic web 120, in accordance with an exemplary embodiment of the present invention, the metallizer 500 of FIG. 7 can generate a selectively metallized holographic web 130 in register with the holographic image, thereby eliminating the need for the registered demetallizing machine 200. As shown in FIG. 7, the metallizer 500 comprises a vacuum chamber 510, a pattern print unit 520, an aluminum source 530 (or a source of chrome or other comparable material), an aluminum vaporizing section 540 and a rotating center cylinder 550. A spool of holographic imaged web 125 rotates around the rotating center cylinder 550 and visits various processing stations or units of the metallizer 500. The pattern print unit 520 applies metallizating resistant image patterns, preferably in registered with the holographic image, onto the holographic imaged web 125. Aluminum from the aluminum source 530 adheres to areas of the holographic imaged web 125 not imaged by the printed patterns in the aluminum vaporizing section 540. This is the process by which the metallizer 500 produces a selective metallized web 130 in accordance with an exemplary embodiment of the present invention.

Preferably, the amount or density of demetallization or selective metallization is sufficient to reconstruct the holographic image or design.

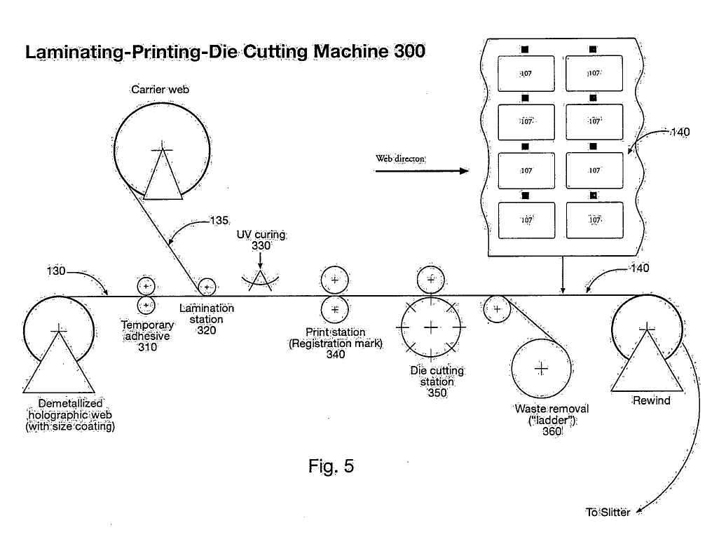

The process by which the holographic overlaminate patch 107 is produced using a laminating/printing/die cutting machine 300 in accordance with an exemplary embodiment of the present invention is now described in conjunction with FIG. 5. The laminating/printing/die cutting machine 300 comprises an adhesive station 310, a lamination station 320, an UV curing station 330, a print station 340 and a die cutting station 350. At the adhesive station 310, the demetallized or selectively metallized holographic web 130 is coated with an adhesive and adhered to a carrier web 135 at the lamination station 320. The combined demetallized holographic web 130 and the carrier web 135 is UV cured at the UV curing station 330. The print station 340 prints a registration mark on the carrier web 135 and the die cutting station 350 cuts the demetallized holographic web to form the holographic overlaminated patch 107, which remains on the carrier web 135 to form the holographic overlay 140. The holographic overlay 140 is wound into individual spools (e.g., one wide) for mounting on the dye sublimation printer, such as the ID card printer/laminator 400, by the laminating/printing/die cutting machine 300. The waste removal or ladder 360 removes or winds the cutout portions of the selectively metallized or demetallized holographic web 130.

Turning now to FIG. 6, there is illustrated an ID card printer/laminator 400 in accordance with an exemplary embodiment of the present invention. The ID card printer/laminator 400 comprises a printer or printing station 1 and a laminator or laminating station 2. The printer 1 applies an image to the blank card using the image ribbon 410 comprising four consecutive color bars to generate an identification card 101. Preferably, the printer 1 performs four consecutive applications of four colors to apply variable information on the blank card in color including a colored photograph. The identification card 101 then moves to the laminating station 2 of the ID card printer/laminator 400. The laminator 2 applies the holographic overlaminate patch 107 from the holographic overlay 140 automatically in register to each identification card 101, and by design allows unobstructed viewing of the relevant identification information. In this particular case there is a superposition of the holographic design and the underlying information of interest: the 30% screen creates a subdued holographic effect that does not overwhelm the identification data or cardholder photo but at the same time creates a protective holographic overlay that suppresses illicit attempts to modify the underlying information. Further, the 100% metallized 5 mm strip along the top of the card allows for quick authentication of the card as the holographic effect is maximized here and is relatively easy to identify, even in weak lighting conditions.

In accordance with an exemplary embodiment of the present invention, a holographic pressure-sensitive label is provided for use on a new software release or a pharmaceutical package (where text on the printed box must be visible) as an anti-counterfeiting measure. The label can be fixed to the software outer package with a labeling machine, so as to serve as a seal for the box top and simultaneously protect the encrypted regional issue code from modification. The issue code is printed on the individual outer package surfaces prior to affixing the holographic label. The manufacturer (i.e. the client) wants the label to diffract brightly in the region that carries their corporate logo, but wants the underlying encrypted issue code to be viewable by the retailers. The holographic label is designed in accordance with the client's wishes: the holographic layer design is made to coincide with the discontinuous metallized layer design so as to provide both the brightly diffracting logo and the clear area through which the issue code will be seen. A holographic origination is generated as described herein. A stamper is generated in the same way, and is mounted to a cylinder that is then used to impress the holographic microstructure into a liquid resin that has been coated on a polyester web. The resin is continuously cured in situ with a non-ionizing radiation source before it is separated from the nickel stamper. It is appreciated that a holographic web can be manufactured using other known techniques, such as embossing. The holographic web is metallized with aluminum as hereinabove, and is demetallized with the discontinuous metallization pattern specific to this application. The demetallized web is adhesive coated, applied to a release liner, die cut, slit, and wound into finished rolls. The finished rolls are mounted on a Label-Aire labeling machine and applied to the software boxes in register with the issue code and folded across the top seam, sealing the container. The discontinuous metallized layer allows unobstructed viewing of the issue code with simultaneous maximum diffraction of the corporate logo.

It is appreciated that the holographic overlay of the present invention can be applied any document, including but not limited to an identification card, a credit card, a note, an official document, a bill, a label and a package.

While the present invention has been particularly described with respect to the illustrated embodiment, it will be appreciated that various alterations, modifications and adaptations may be made based on the present disclosure, and are intended to be within the scope of the present invention. It is intended that the appended claims be interpreted as including the embodiment discussed above, those various alternatives which have been described and all equivalents thereto.

1. A holographic overlay comprising a plurality of zones of varying transmittance to increase viewability of underlying information-bearing areas of a document and holographic design.

2. The holographic overlay of claim I, wherein said plurality of zones are generated and applied in register to said underlying document.

3. The holographic overlay of claim 1, wherein said plurality of zones are generated and applied in register to both said underlying document and said holographic design.

4. The holographic overlay of claim 1, further comprising a plurality of zones of enhanced diffraction areas.

5. The holographic overlay of claim 1, wherein said document is one of the following: an identification card, a credit card, an official document, a note, a bill, a label and a package.

6. The holographic overlay of claim 2, wherein said holographic design is a repeating holographic design.

7. The holographic overlay of claim 1, wherein said plurality of zones of varying transmittance is form by selectively metallizing a holographic layer with a discontinuous metallization pattern.

8. The holographic overlay of claim 7, wherein said discontinuous metallization pattern is sufficient to reconstruct said holographic design.

9. The holographic overlay of claim 1, wherein said plurality of zones of varying transmittance is form by demetallizing a metallized holographic layer with a discontinuous metallization pattern.

10. The holographic overlay of claim 9, wherein said discontinuous metallization pattern is sufficient to reconstruct said holographic design.

11. A document utilizing the holographic overlay of claim 1.

12. A document utilizing the holographic overlay of claim 2.

13. A document utilizing the holographic overlay of claim 3.

14. A document utilizing the holographic overlay of claim 4.

15. A method of generating holographic overlay, comprising the steps of:
metallizing a holographic layer comprising a holographic design; and
demetallizing said metallized holographic layer with a discontinuous metallization pattern to provide said holographic overly comprising multiple zones of dissimilar transmittance.

16. The method of clam 15, further comprising the step of applying said holographic layer overlay on a document, thereby increasing the viewability of underlying information-bearing areas of said document.

17. The method of claim 16, further comprising the step of generating and applying said multiple zones of dissimilar transmittance in register to said underlying document.

18. The method of claim 16, further comprising the step of generating and applying said multiple zones of dissimilar transmittance in register to both said underlying document and said holographic design.

19. The method of claim 15, further comprising the step of generating a plurality of zones of enhanced diffraction areas in said holographic overlay.

20. The method of claim 16, wherein the step of applying comprises the step of applying said holographic overlay to one of the following document to enhance security: an identification card, a credit card, an official document, a note, a bill, a label and a package.

21. The method of claim 15, further comprising step of generating said holographic layer comprising a repeating holographic design.

22. The method of claim 15, wherein the step of demetallizing comprises the step of demetallizing said metallized holographic layer sufficient to reconstruct said holographic design.

23. A method of generating holographic overlay, comprising the steps of:
applying a metallizating resistant image pattern to a holographic imaged layer comprising a holographic design; and
selectively metallizing said holographic imaged layer with a discontinuous metallization pattern to provide said holographic overly comprising multiple zones of dissimilar transmittance.

24. The method of clam 23, further comprising the step of applying said holographic layer overlay on a document, thereby increasing the viewability of underlying information-bearing areas of said document.

25. The method of claim 24, further comprising the step of generating and applying said multiple zones of dissimilar transmittance in register to said underlying document.

26. The method of claim 24, further comprising the step of generating and applying said multiple zones of dissimilar transmittance in register to both said underlying document and said holographic design.

27. The method of claim 23, further comprising the step of generating a plurality of zones of enhanced diffraction areas in said holographic overlay.

28. The method of claim 24, wherein the step of applying comprises the step of applying said holographic overlay to one of the following document to enhance security: an identification card, a credit card, an official document, a note, a bill, a label and a package.

29. The method of claim 23, further comprising step of generating said holographic layer comprising a repeating holographic design.

30. The method of claim 23, wherein the step of selectively metallizing comprises the step of selectively metallizing said holographic imaged layer sufficient to reconstruct said holographic design.
